(19) United States
(12) Patent Application Publication
(10) Pub. No.: US 2026/0327111 A1
(43) Pub. Date: Oct. 22, 2026

(54) STAGGERED GAS SUPPLY DEVICE AND MINIATURIZED STRUCTURAL INTEGRATED MEMBRANE BIOREACTOR CONTAINING THE SAME

(71) Applicant: MEGA UNION TECHNOLOGY INCORPORATED, Taoyuan City (TW)

(72) Inventors: Kuo-Ching LIN, Taoyuan City (TW); CHIEH YAO HOU, Taoyuan City (TW); CHUNG JEN LEE, Taoyuan City (TW); JIA LU HUANG, Taoyuan City (TW)

(21) Appl. No.: 19/652,330

(22) Filed: Apr. 20, 2026

(30) Foreign Application Priority Data
Apr. 21, 2025 (TW) 114114922

(51) Int. Cl. C02F 3/20; B01F 23/231; B01F 101/00; C02F 3/12

(52) U.S. Cl. CPC C02F 3/201; B01F 23/231121; B01F 23/23113; B01F 23/231153; B01F 23/231231; C02F 3/1268; B01F 2101/305

(57) ABSTRACT

A staggered gas supply device and a miniaturized structural integrated membrane bioreactor including the same are provided. The staggered gas supply device includes at least one gas supply pipe, a plurality of gas collection chambers, and a plurality of first aeration columns. The gas collection chambers are arranged along a first direction of the gas supply pipes. The at least one gas supply pipe is in gas communication with the gas collection chambers. The first aeration columns each include an aeration chamber. The aeration chambers abut against one sidewall of the gas collection chambers. The first aeration columns extend beyond the at least one gas supply pipe along a second direction intersecting with the at least one gas supply pipe.

### BACKGROUND OF THE INVENTION

### 1. Field of the Invention

The present disclosure relates to a gas supply device and a membrane comprising the same, and more particularly to a lightweight, energy-saving, and low-loss interleaved gas supply device and a miniaturized structural integrated membrane bioreactor comprising the same.

### 2. Description of the Prior Art

Membrane Bioreactors (MBRs) are used in wastewater and industrial wastewater treatment systems. Traditional MBRs, due to the independent module structure and piping, are prone to long-term sludge accumulation inside the modules and between the MBR membranes and piping. The stubborn sludge buildup reduces membrane efficiency, shortens lifespan, and increases maintenance costs. Furthermore, the fixed bubble morphology in traditional MBR modules results in a dynamically stable state for the membrane fibers, where sludge easily accumulates in the unstressed areas of the membrane fibers, leading to insufficient flux and further affecting treatment efficiency.

In addition, traditional MBRs have some common limitations. For example, MBR membranes have high requirements for influent water quality and require pretreatment to remove larger particles and impurities; otherwise, membrane fouling can easily occur, affecting treatment performance. The frequent replacement and backwashing of MBR membranes leads to high operating costs. Furthermore, traditional MBRs are typically bulky and heavy, thereby restricting their use in confined spaces and complicating their transport and installation. Traditional membranes require a large amount of electricity to maintain the operation, including electricity for aeration and electricity for backwashing the membrane modules. The high cost of electricity is also an important factor limiting the application of MBRs.

### SUMMARY OF THE INVENTION

Therefore, the present disclosure provides a method for reducing hardness in wastewater while removing waste gas, which can overcome the disadvantages of the prior art.

The present disclosure provides a staggered gas supply device, including the following:
at least one gas supply pipe;
a plurality of gas collection chambers arranged along a first direction of the gas supply pipes, the at least one gas supply pipe being in gas communication with the gas collection chambers; and
a plurality of first aeration columns, each including: an aeration chamber abutting against a sidewall of the gas collection chambers, wherein the first aeration columns extend beyond the at least one gas supply pipe along a second direction intersecting the at least one gas supply pipe.

Preferably, the aeration chamber includes a gas baffle and A gas inlet, the gas baffle defines a vortex channel on a sidewall of the gas collection chamber, the gas inlet penetrates the sidewall and is in gas communication with a front end of the vortex channel.

Preferably, the staggered gas supply device further includes a plurality of second aeration columns abutting against another sidewall of the gas collection chambers, wherein gas outlets of the second aeration columns are larger than or equal to gas outlets of the first aeration column.

Preferably, the staggered gas supply device further includes an aeration pipe spaced apart from the at least one gas supply pipe, wherein a wall of the aeration pipe includes a plurality of aeration holes.

Preferably, the staggered gas supply device further includes a first disturbance mode and a second disturbance mode, wherein the first aeration columns intermittently discharge a plurality of first bubbles in a pulsed manner in the first disturbance mode, and the aeration holes continuously discharge a plurality of second bubbles in the second disturbance mode, the first disturbance mode and the second disturbance mode interact to form turbulence with irregular disturbances.

Furthermore, the present disclosure provides a miniaturized structural integrated membrane bioreactor including the aforementioned staggered aeration device, including a gas-liquid co-structured frame. The gas-liquid co-structured frame includes the following:
a first hollow frame defining a first perimeter of a first side surface of the gas-liquid co-structured frame, the four sides of the first hollow frame being in liquid communication with each other;
a second hollow frame defining a second perimeter of a second surface side of the gas-liquid co-structured frame, the first side being parallel to the second side, the four sides of the second hollow frame being in liquid communication with each other;
a plurality of water production pipes connected between the first hollow frame and the second hollow frame, the water production pipes being in liquid communication with each other; and
the staggered aeration device is disposed between the first hollow frame and the second hollow frame, at least one aeration pipe of the staggered aeration device is in gas communication with the second hollow frame and is disposed below the water production pipes, and the first aeration columns extending from the staggered aeration device to a side surface of the water production pipes.

Preferably, the staggered aeration device includes a plurality of aeration pipes disposed between the first hollow frame and the second hollow frame and between the water production pipes, the aeration pipes are in gas communication with the second hollow frame.

The staggered aeration device includes a first disturbance mode and a second disturbance mode, wherein the first aeration columns intermittently discharge a plurality of first bubbles in a pulsed manner in the first disturbance mode, and the aeration holes continuously discharge a plurality of second bubbles in the second disturbance mode, the first disturbance mode and the second disturbance mode interact to form turbulence with irregular disturbances.

Preferably, the staggered aeration device includes a plurality of second aeration columns abutting against another sidewall of the gas collection chambers, gas outlets of the second aeration columns are larger than or equal to gas outlets of the first aeration columns.

The staggered aeration device includes a first disturbance mode and a second disturbance mode, wherein the first aeration columns intermittently discharge a plurality of first bubbles in a pulsed manner in the first disturbance mode, and the aeration holes continuously discharge a plurality of second bubbles in the second disturbance mode, the first disturbance mode and the second disturbance mode interact to form turbulence with irregular disturbances.

Preferably, the miniaturized structural integrated membrane bioreactor further includes an I-shaped hanger configured to define a suspension point on a central axis of the miniaturized structural integrated membrane bioreactor.

Preferably, an operating flux of the miniaturized structural integrated membrane bioreactor is 18-22.5 LMH.

Preferably, a fouling rate of the miniaturized structural integrated membrane bioreactor is 20-50%.

Preferably, an aeration rate of the miniaturized structural integrated membrane bioreactor is 2.5-3.5 CMM.

The present disclosure provides a multi-union non-blocking staggered gas supply device. The gas supply pipe supplies gas to the gas collection chamber through the gas supply branch pipe. The aeration column abuts against the sidewall of the gas collection chamber to form two independent structures to establish an indirect aeration mode. A gas inlet is established at the top of the sidewall of the gas collection chamber, so that the gas inlet and the bottom of the gas collection chamber have a first distance, ensuring that the gas collection chamber is always full of gas during the aeration process, thereby avoiding aeration function failure due to sludge blockage in the gas collection chamber. Furthermore, the aeration column extends beyond the gas supply pipe to the side surface of the water production pipe, extending the second distance between the gas outlet and the gas inlet of the aeration column and shortening the distance between the gas outlet and the MBR membrane fiber. This allows the aeration column to not only control the size, direction and pressure of the bubbles, but also to accumulate gas and intermittently discharge large bubbles in a pulsed manner. The multi-union non-blocking staggered gas supply device of the present disclosure is further provided with an aeration pipe and a gas supply pipe spaced apart to establish a continuous aeration mode. Small bubbles are continuously discharged on the other side of the MBR membrane fiber. The intermittent large bubbles and continuous small bubbles of the multi-union non-blocking staggered gas supply device of the present disclosure generate staggered mixed bubble disturbances on the left and right sides of the MBR membrane fiber to form turbulence, causing the MBR membrane fiber to oscillate irregularly without resonance, reducing the sludge accumulation area of the local non-disturbance zone, thereby peeling off the sludge accumulated on the surface of the MBR membrane fiber during filtration, and also reducing the attachment of suspended sludge to the MBR membrane fiber.

Furthermore, the miniaturized structural integrated membrane bioreactor of the present disclosure having aforementioned the multi-union non-blocking staggered aeration device forms the water production pipeline and aeration pipeline within a metal frame using a gas-liquid co-structure frame, shortening the flow path of the water and gas flow within the frame. The small-size membrane frame design helps to dissipate energy losses in the water and gas flow within the pipelines. The gas-liquid co-structure frame eliminates the need for independent plastic piping, reducing the need for additional metal support structures via clamping or other fixing methods. This reduces assembly components and procedures while maintaining structural strength. The reduced size of each module increases the water flow area within the mold tank for brushing, and the design without cover plates helps distribute the water/gas flow field within the mold tank beyond the module itself. This external flow field directly enhances the side brushing of the outer membrane, effectively utilizing the brushing effect of the flow field within the mold tank on the membrane fiber surface. By reducing branch piping and fittings, the fluid resistance around and inside the MBR membrane fibers is reduced, facilitating brushing from the side surfaces of the MBR membrane fibers by a staggered gas supply device. This reduces unnecessary aeration energy waste while still effectively reducing sludge buildup. Therefore, the gas-liquid co-structure frame of the present disclosure features minimal piping, minimal fittings, overall lightweight design, minimal energy consumption, fewer maintenance parts, and maximized service life.

### BRIEF DESCRIPTION OF THE DRAWINGS

Other features and effects of the present disclosure will be clearly presented with reference to the illustrated embodiments, wherein:

FIG. 1 is a schematic perspective view of a first embodiment of a miniaturized structural integrated membrane bioreactor.

FIG. 2 is a schematic perspective view of a second embodiment of a miniaturized structural integrated membrane bioreactor.

FIG. 3 is a schematic perspective view of a gas-liquid co-structure frame.

FIG. 4 is a schematic perspective view of a first embodiment of an interleaved gas supply device.

FIG. 5 is a schematic perspective view of a second embodiment of an interleaved gas supply device.

FIG. 6 is a schematic perspective view of a third embodiment of an interleaved gas supply device.

FIG. 7 is a schematic enlarged view of a first embodiment of an interleaved gas supply device.

FIG. 8 is a schematic cross-sectional view of the interleaved gas supply device of FIG. 7.

FIG. 9 is a schematic enlarged view of a second embodiment of an interleaved gas supply device.

FIG. 10 is a schematic enlarged view of the third embodiment of the staggered gas supply device.

FIG. 11 is a schematic side view of the first embodiment of the miniaturized structural integrated membrane bioreactor.

FIG. 12 is a schematic side view of the second embodiment of the miniaturized structural integrated membrane bioreactor.

FIG. 13 is a schematic side view of the third embodiment of the miniaturized structural integrated membrane bioreactor.

### DESCRIPTION OF THE PREFERRED EMBODIMENTS

The present disclosure will be further described with reference to the following embodiments. However, it should be understood that these embodiments are for illustrative purposes only and should not be construed as limiting the implementation of the present disclosure.

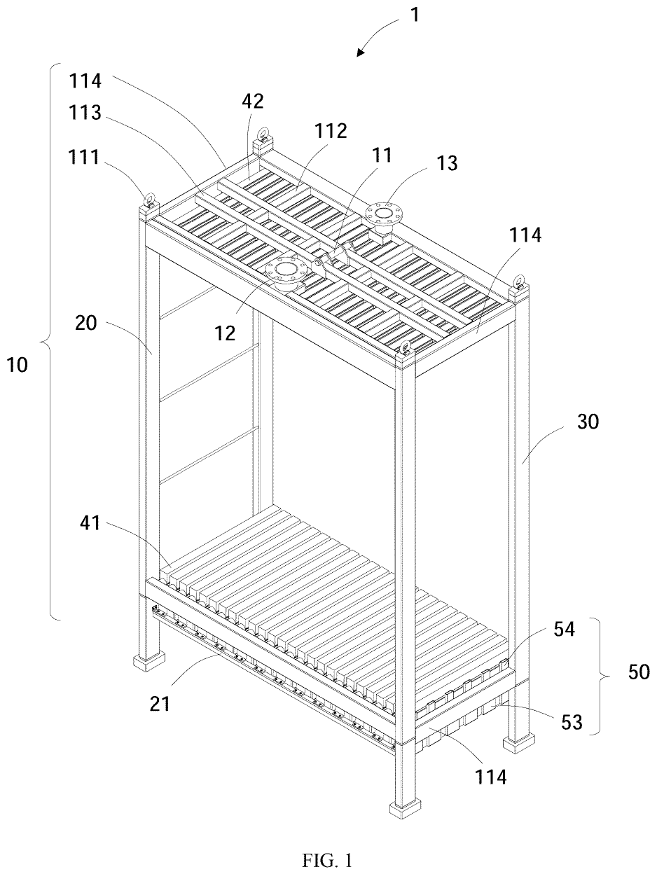

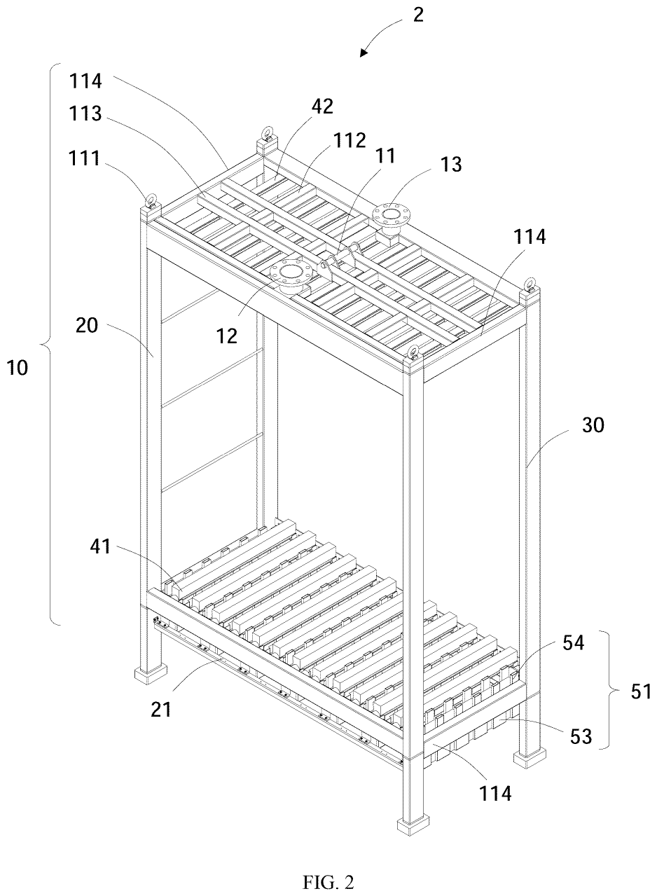

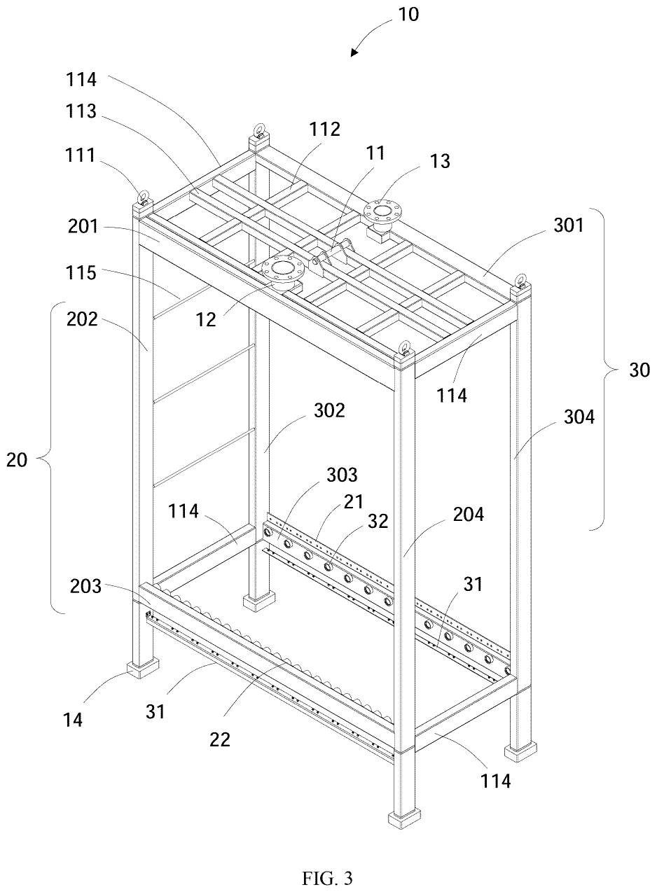

Please refer to FIGS. 1-3. FIG. 1 is a schematic perspective view of a first embodiment of a miniaturized structural integrated membrane bioreactor, FIG. 2 is a schematic perspective view of a second embodiment of a miniaturized structural integrated membrane bioreactor, and FIG. 3 is a schematic perspective view of a gas-liquid co-structure frame. The difference between the first and second embodiments lies in the configuration of the water production pipe and the staggered gas supply device in the miniaturized structural integrated membrane bioreactor 1 and the miniaturized structural integrated membrane bioreactor 2. The miniaturized structural integrated membrane bioreactor 1 is suitable for staggered gas supply devices 50 and 501, while the miniaturized structural integrated membrane bioreactor 2 is suitable for staggered gas supply device 51.

The miniaturized structural integrated membrane bioreactors 1-2 of the present disclosure is provided with a gas-liquid co-structure frame 10 and a multi-union non-blocking staggered gas supply device 50. The gas-liquid co-structure frame 10 is a three-dimensional metal support for the miniaturized structural integrated membrane bioreactors 1-2. The staggered gas supply device 50 is positioned at the bottom of the gas-liquid co-structure frame 10.

The gas-liquid co-structure frame 10 is provided with a water production flange 12, a first hollow frame 20, a gas supply flange 13, and a second hollow frame 30. The first hollow frame 20 defines the first perimeter of the first side of the gas-liquid co-structure frame 10, that is, the first to fourth water production frames 201-204 of the first hollow frame 20 are all hollow pipes and liquid flows between them. The water production flange 12 is positioned on the first water production frame 201, preferably in the middle of the first water production frame 201, to discharge the liquid filtered by MBR membrane fibers 40 and collected from the first to fourth water production frames 201-204. The second hollow frame 30 defines a second perimeter of a second side of the gas-liquid co-structure frame 10. The first to fourth gas supply frames 301-304, which form the four sides of the second hollow frame 30, are all hollow channels and are in gas communication with each other. A gas supply flange 13 is positioned on the first gas supply frame 301, preferably in the middle of the first gas supply frame 301, to inject gas into the first to fourth gas supply frames 301 to 304 for delivery to the staggered gas supply device 50. The gas-liquid co-structure frame 10 may be provided with a base 14 to enhance the stability within the activated sludge treatment tank.

The water production pipe is connected between the first hollow frame 20 and the second hollow frame 30. The water production pipe is provided with a first water production pipe 41 and a second water production pipe 42 arranged in pairs. The MBR membrane fiber 40 is connected between the first water production pipe 41 and the second water production pipe 42 to transport the liquid filtered by the MBR membrane fiber 40 to the water production pipe. The water production pipes can be arranged parallel to each other along the second direction DR2 (i.e., the width direction). One end of the first water production pipe 41 is connected to the third water production frame 203 of the first hollow frame 20 through the water production connection structure 22, and the other end is sealed. The other end can be fixed to the first support frame 21 of the third gas supply frame 303 with screws or other fixing means. The second water production pipe 42 is connected to the first water production frame 201 through the water production connection structure 22 of the third water production frame 203, and the other end is sealed. The other end can be fixed to the third gas supply frame 303 with screws or other fixing means. The water production connection structure 22 can be any connecting element that provides a hollow connection, such as one with a threaded opening to be screwed onto the end opening of the second water production pipe 42 while maintaining liquid communication.

Therefore, the gas-liquid co-structure frame 10 can shorten the flow path of water and gas within the frame, effectively avoiding energy loss within the piping, while also avoiding the need for additional metal or plastic piping, thus reducing the overall weight of the miniaturized structural integrated membrane bioreactors 1-2. Furthermore, the gas-liquid co-structure frame 10 can connect the first hollow frame 20 and the second hollow frame 30 via a first connecting rod 114 and/or a second connecting rod 115, allowing the first hollow frame 20 or its first side to be parallel to the second hollow frame 30 or its second side. The first connecting rod 114 and/or the second connecting rod 115 define and reinforce the distance and structural strength between the first hollow frame 20 and the second hollow frame 30, thereby uniformly distributing water and gas flow.

In addition, the top surface of the gas-liquid co-structure frame 10 may be provided with a first reinforcing rod 112, a second reinforcing rod 113, an I-shaped hanger (i.e., an I-beam hanger) 11, and a lifting ring 111. The first reinforcing rod 112 is connected between the first water production frame 201 and the first gas supply frame 301. The second reinforcing rod 113 is connected to two parallel fourth connecting rods on the top surface of the gas-liquid co-structure frame 10 to distribute the force and load during suspension and increase the stability of the suspended gas-liquid co-structure frame 10. The I-shaped hanger 11 is provided on the first reinforcing rod 112 and/or the second reinforcing rod 113. Preferably, the I-shaped hanger 11 is provided at the center or central axis of the top surface of the gas-liquid co-structure frame 10. The lifting ring 111 is provided at the end of the first water production frame 201 and the end of the first gas supply frame 301. The lifting ring 111 may be provided in pairs diagonally or at all four corners. When using an overhead crane to suspend the gas-liquid co-structure frame 10, the steel cable can pass through the I-shaped hanger 11 and each lifting ring 111. The suspension length of the steel cable can be defined by the height of the I-shaped hanger 11, and the lifting point is defined at the central axis of the I-shaped hanger 11 of the miniaturized structural integrated membrane bioreactor. This reduces the ceiling height required to suspend the gas-liquid co-structure frame 10, which is beneficial for relocation operations in plant areas with low mezzanine height or limited height.

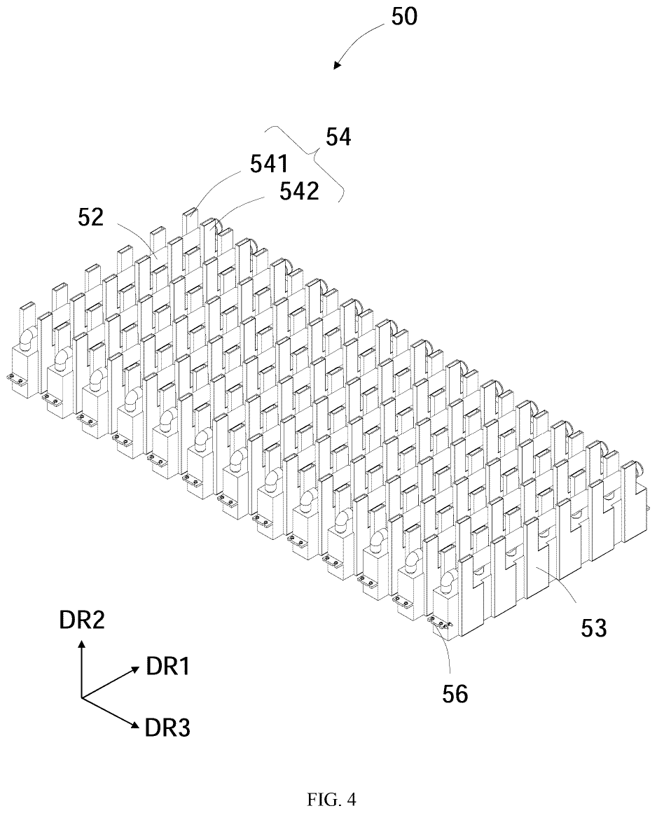

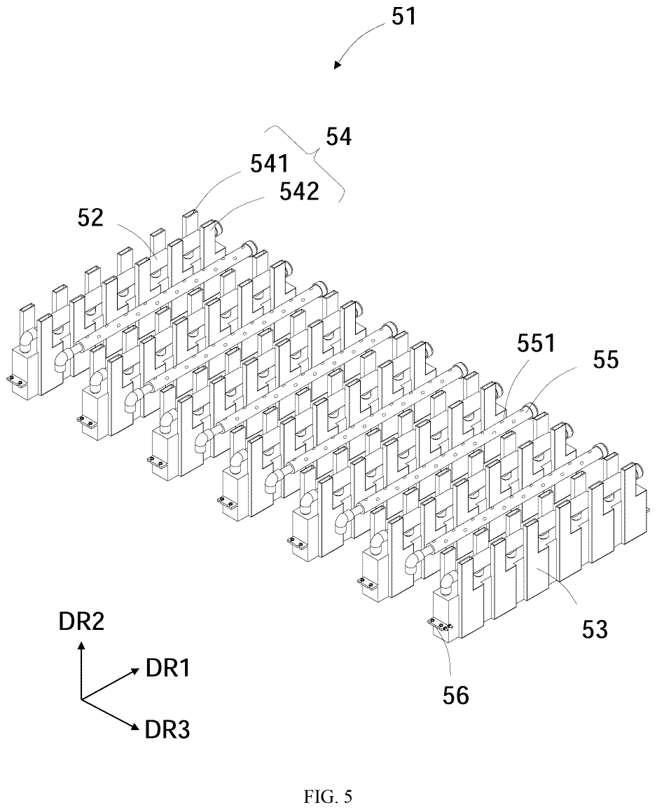

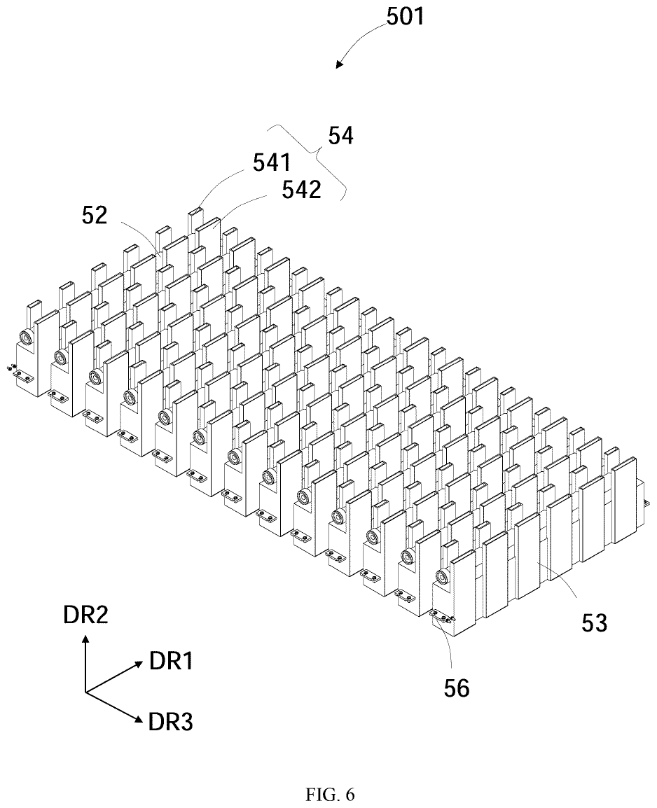

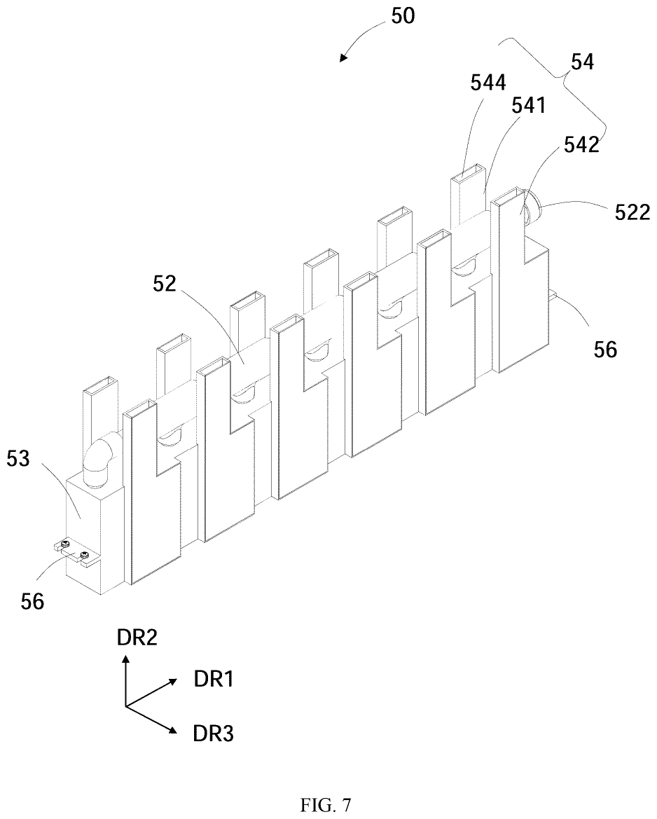

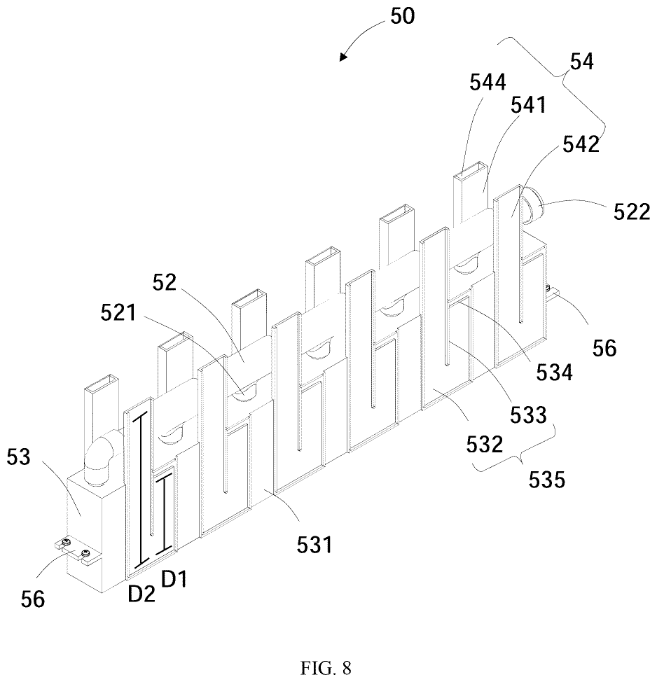

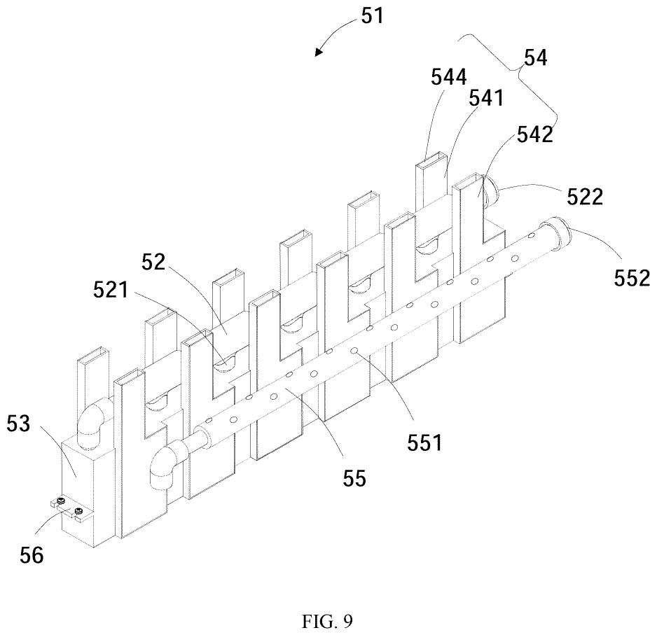

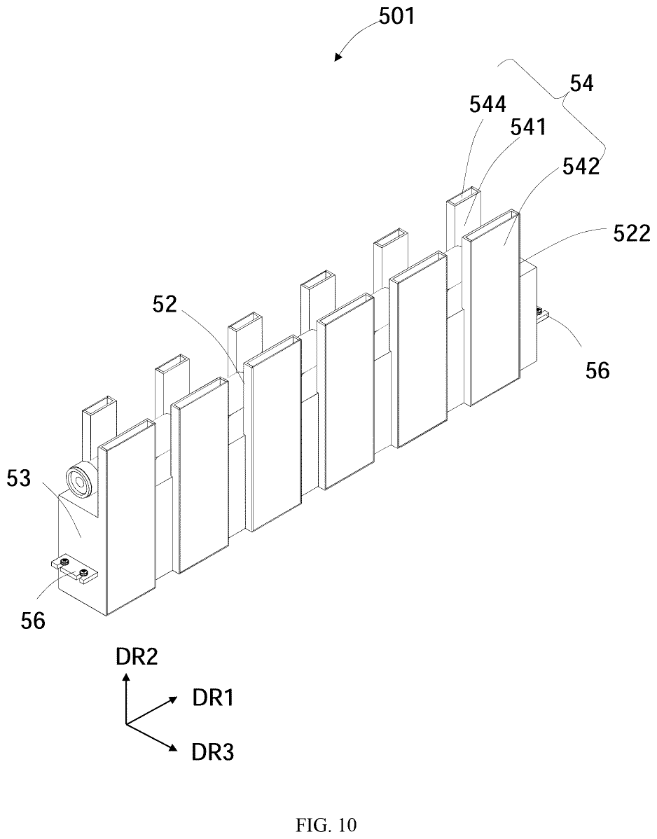

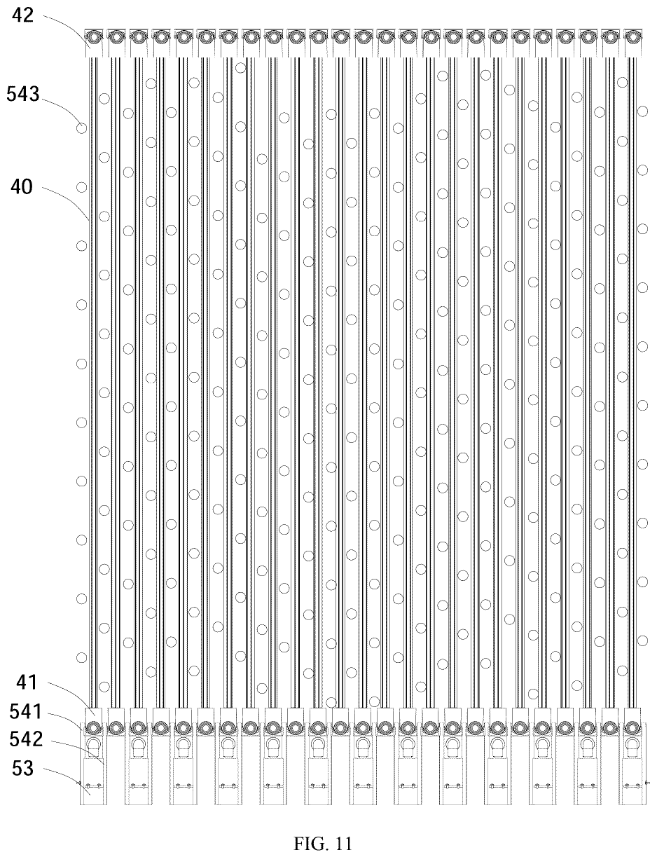

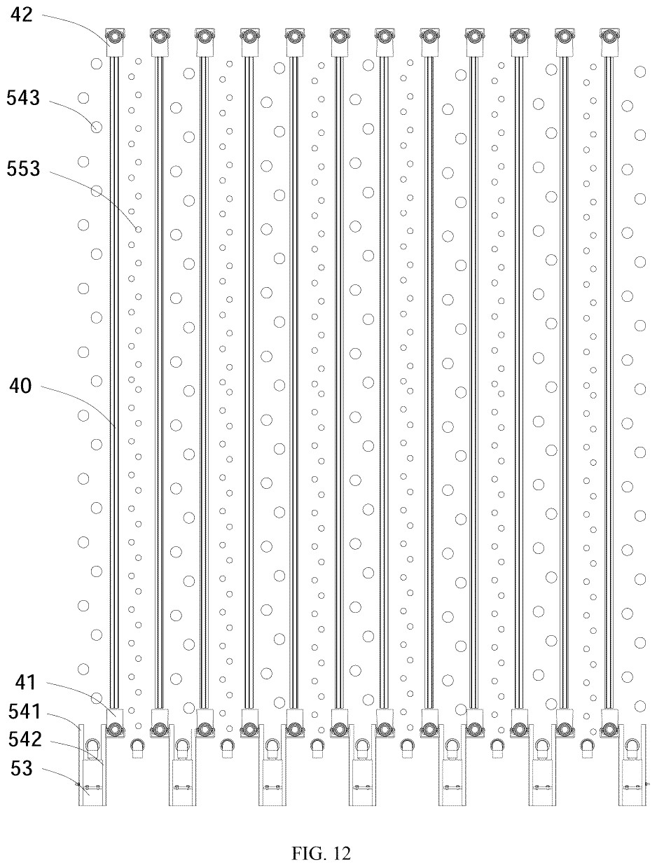

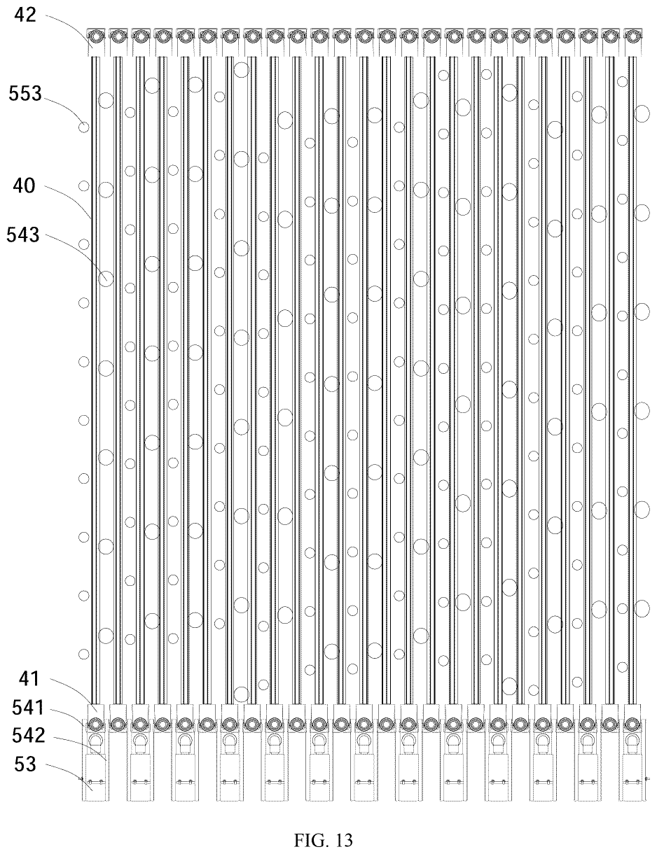

Please refer to FIGS. 4-13. FIG. 4 is a schematic perspective view of the first embodiment of the interleaved gas supply device; FIG. 5 is a schematic perspective view of the second embodiment of the interleaved gas supply device; FIG. 6 is a schematic perspective view of the third embodiment of the interleaved gas supply device; FIG. 7 is a schematic enlarged view of the first embodiment of the interleaved gas supply device; FIG. 8 is a schematic cross-sectional view of the interleaved gas supply device of FIG. 7; FIG. 9 is a schematic enlarged view of the second embodiment of the interleaved gas supply device; FIG. 10 is a schematic enlarged view of the third embodiment of the interleaved gas supply device; FIG. 11 is a schematic side view of the first embodiment of the miniaturized structural integrated membrane bioreactor; FIG. 12 is a schematic side view of the second embodiment of the miniaturized structural integrated membrane bioreactor; and FIG. 13 is a schematic side view of the third embodiment of the miniaturized structural integrated membrane bioreactor.

The first embodiment of the interleaved gas supply device 50 is provided with a gas supply pipe 52, a gas collection chamber 53, and an aeration column 54. The gas supply pipe 52 is positioned below the first water production pipe 41. Preferably, the gas supply pipe 52 is aligned with the first water production pipe 41. The gas supply pipe 52 connects between the first hollow frame 20 and the second hollow frame 30. The gas supply pipe inlet 522 at the end of the gas supply pipe 52 is in gas communication with the third gas supply frame 303 of the second hollow frame 30 via the gas supply connection structure 32 disposed on the third gas supply frame 303. The other end of the gas supply pipe 52 is in gas communication with respective gas collection chambers 53 via respective gas branch pipes 521. The gas supply connection structure 32 can be any connecting element that provides a hollow connection, such as one with a threaded opening, to be screwed into the end opening of the gas supply pipe 52 while maintaining liquid communication. The gas collection chamber 53 is positioned below the gas supply pipe 52 and is arranged along a first direction DR1 or the length direction of the gas supply pipes 52. One side of the gas collection chamber 53 is connected to a third water production frame 203 by a fixing member 56, which can be fixed to the third water production frame 203 by screws or other fixing methods.

The aeration column 54 is provided with a first aeration column 541 and/or a second aeration column 542. Both the first aeration column 541 and the second aeration column 542 are provided with an aeration chamber 532. The aeration chamber 532 abuts against the sidewall 531 of the gas collection chamber 53. The first aeration column 541 and the second aeration column 542 extend beyond the gas supply pipe 52 along a third direction DR3 (i.e., the height direction) intersecting with the gas supply pipe 52, and extend to the side surface of the first water production pipe 41 to release first bubble(s) 543. The size of the first bubble 543 is 8-12 mm.

The aeration chamber 532 of the first aeration column 541 and/or the second aeration column 542 is provided with a gas baffle 533 and a gas inlet 534. The gas baffle 533 defines a swirling flow channel 535 on the sidewall 531 of the gas collection chamber 53. The gas inlet 534 penetrates the top of the sidewall 531 of the gas collection chamber 53 and is in gas communication with the front end of the swirling flow channel 535, so that the gas inlet 534 and the bottom of the gas collection chamber 53 have a first distance D1, ensuring that the gas collection chamber 53 is always filled with gas during aeration, which can avoid the problem of aeration failure due to sludge blockage in the gas collection chamber. The bottom of the aeration chamber 532 and the gas outlet 544 of the aeration column 54 have a second distance D2. The first distance D1 is greater than or equal to the second distance D2.

Therefore, the staggered gas supply device 50, by independently configuring the gas collection chamber 53 and the aeration chamber 532. Gas is initially supplied to the gas collection chamber 53. This avoids the problem of gas supply failure caused by sludge blockage in the gas collection chamber 53. It is a non-blocking staggered gas supply device 50, which can extend the service life of the MBR and reduce maintenance costs.

The difference between the first and second embodiments of the staggered gas supply device 50 is that the staggered gas supply device 51 of the second embodiment is further provided with an aeration pipe 55. The aeration pipe 55 is positioned between the first hollow frame 20 and the second hollow frame 30. The aeration pipe inlet 552 at the end of the aeration pipe 55 is in gas communication with the third gas supply frame 303 of the second hollow frame 30 via the gas supply connection structure 32 disposed on the third gas supply frame 303. The other end is sealed and can abut against the second support frame 31 of the third gas supply frame 303, or be fixed to the second support frame 31 of the third gas supply frame 303 with screws or other locking structures. The aeration pipe 55 and the gas supply pipe 52 are spaced apart, and the aeration pipe 55 is disposed between a plurality of first water production pipes 41. A plurality of aeration holes 551 are formed on the pipe wall of the aeration pipe 55. The aeration holes 551 can be arranged along the first direction DR1, and the aeration holes 551 can be staggered to release second bubble(s) 553 in irregular positions. The size of the second bubble 553 is 2-5 mm.

The staggered gas supply device 50 is provided with a first disturbance mode and a second disturbance mode. The first aeration column 541 and/or the second aeration column 542 intermittently discharge first bubbles 543 in a pulsed manner in a first disturbance mode, while the aeration holes 551 continuously discharge the second bubbles 553 in the second disturbance mode. The first bubbles 543 are larger than the second bubbles 553. The first disturbance mode and the second disturbance mode interact to form turbulence and/or vortices with irregular disturbances. In the first perturbation mode, the frequency of the first bubble 543 discharged by the staggered aeration device 50 is 45-90 bubbles/minute, while the frequency of the second bubble 553 discharged by the second perturbation mode is 180-540 bubbles/minute. The frequency ratio of the first bubble 543 to the second bubble 553 is 0.25-0.17, and the size ratio of the first bubble 543 to the second bubble 553 is 8-12:2-5.

Therefore, the second embodiment of the staggered aeration device 50 generates mixed bubbles using two perturbation modes. The irregular perturbation caused by the pulsed intermittent large bubbles and continuous small bubbles results in uneven stress on the membrane fibers, causing irregular oscillations, preventing sludge accumulation, and extending the service life of the miniaturized structural integrated membrane bioreactors 1-2.

The difference between the staggered gas supply device 50 of the first embodiment and the staggered gas supply device 501 of the third embodiment is that the gas outlets 544 of the first aeration column 541 and that of the second aeration column 542 of the staggered gas supply device 50 of the first embodiment have the same pipe diameter. In the staggered gas supply device 501 of the third embodiment, the gas outlet 544 of the second aeration column 541 has a larger pipe diameter than the gas outlet 544 of the first aeration column 542, and the aeration chamber 532 of the second aeration column 541 only has a gas inlet 534 and no gas baffle 533, while the aeration chamber 532 of the first aeration column 541 has a gas baffle 533 and a gas inlet 534. The aperture of the gas inlet 534 of the second aeration column 541 can be equal to or larger than the gas inlet 534 of the first aeration column 542, so that the release frequency of the first bubble 543 released by the second aeration column 541 is less than the release frequency of the second bubble 543 released by the first aeration column 541.

The staggered gas supply device 501 of the third embodiment features a first disturbance mode and a second disturbance mode. The second aeration column 541 pulses and intermittently discharges first bubbles 543 in the first disturbance mode, while the first aeration column 542 continuously discharges second bubbles 553 in the second disturbance mode. The first bubbles 543 are larger than the second bubbles 553. The first and second disturbance modes interact to form turbulence and/or vortices with irregular disturbances. In the first disturbance mode, the frequency of first bubbles 543 discharged by the staggered gas supply device 50 is 45-90 bubbles/minute, while the frequency of second bubbles 553 discharged by the second disturbance mode is 180-540 bubbles/minute. The frequency ratio of the first bubbles 543 to the second bubbles 553 is 0.25-0.17, and the size ratio of the first bubbles 543 to the second bubbles 553 is 8-12:2-5.

Therefore, the staggered gas supply device 501 of the third embodiment generates mixed bubbles using two disturbance modes. Through pulsed intermittent large bubbles and continuous small bubbles, non-co-frequency irregular disturbances are generated. The turbulence formed by the disturbances and the collision thrust of the bubbles create an irregular resultant force on the membrane fibers, causing uneven force on the left and right sides of the membrane fibers, resulting in irregular oscillation and bending. This removes the sludge accumulated on the surface of the MBR membrane fibers 40 during filtration, prevents sludge accumulation, and extends the service life of the miniaturized structural integrated membrane bioreactors 1-2.

The empty weight of a traditional membrane bioreactor is approximately 2 tons, and the weight after sludge accumulation is approximately 5-6 tons. The complex structure and components are prone to leakage. Sealing plates on all sides lead to sludge accumulation on the MBR membrane fibers. The average fouling rate of traditional membrane bioreactors is 40-90%, with a fouling rate greater than 5 kPa/day. An aeration rate of 5 CMM is required for stable operation, and the service life is less than 5 years.

Compared with traditional membrane bioreactors, as shown in Table 1, the miniaturized structural integrated membrane bioreactor of the present disclosure simplifies and lightens structural components. Through a gas-liquid co-construction frame, the empty weight is approximately 1.0 ton, and the weight of each unit containing sludge can be less than 3.0 tons, preferably 1-3 tons. The miniaturized structural integrated membrane bioreactor reduces leakage and weight, and also reduces the required suspension height, allowing for the use of existing plant tanks and overhead crane beams without engineering upgrades. The average fouling rate of the miniaturized structural integrated membrane bioreactor of the present disclosure is 20-60%, with the average fouling rate reduced to 1-5 kPa/day. The aeration volume required is only 2.5-5.0 cm², preferably 3.5 cm² or less, more preferably 2.5-3.5 cm², reducing the aeration volume by 10-20%. The service life is more than 5 years, increasing the service life by 10-15%. The membrane tank MLSS was 0.9-2.0 g/L, preferably 1.2-2.0 g/L.

TABLE 1

| | Traditional | | | | | | | |
|---|---|---|---|---|---|---|---|---|
| | MBR reactor | | Embodiment 1 | | Embodiment 2 | | Embodiment 3 | |
| Empty weight | 2 | tons | 1.0 | tons | 1.0 | tons | 1.0 | tons |
| Weight including sludge | 5~6 | tons | <2.0 | tons | <2.0 | tons | <3.0 | tons |
| Average fouling rate | 40~90% | | 20~50% | | 20~50% | | 30~60% | |
| Average fouling rate | >5 | kPa/days | 1~3 | kPa/days | 1~3 | kPa/days | 1~5 | kPa/days |
| Aeration rate | >5 | CMM | ≤3.5 | CMM | 3.8~4.0 | CMM | 4.0~5.0 | CMM |
| Service life | <5 | years | >5.5 | years | >5.5 | years | >5 | years |

| | | | | |
|---|---|---|---|---|
| Service life increase rate | 0% | 10~15% | 10~15% | 5~10% |
| Membrane tank MLSS (g/L) | 0.9~1.2 | 0.9~1.2 | 1.2~1.5 | 1.5~2.0 |

The present disclosure provides a multi-union non-blocking staggered gas supply device. The gas supply pipe supplies gas to the gas collection chamber through the gas supply branch pipe. The aeration column abuts against the sidewall of the gas collection chamber to form two independent structures to establish an indirect aeration mode. A gas inlet is established at the top of the sidewall of the gas collection chamber, so that the gas inlet and the bottom of the gas collection chamber have a first distance, ensuring that the gas collection chamber is always full of gas during the aeration process, thereby avoiding aeration function failure due to sludge blockage in the gas collection chamber. Furthermore, the aeration column extends beyond the gas supply pipe to the side surface of the water production pipe, extending the path length between the gas outlet and the gas inlet of the aeration column and shortening the distance between the gas outlet of the aeration column and the MBR membrane fiber. This allows the aeration column to not only control the size, direction and pressure of the bubbles, but also to accumulate gas and intermittently discharge large bubbles in a pulsed manner. The multi-union non-blocking staggered gas supply device of the present disclosure is further provided with an aeration pipe and a gas supply pipe spaced apart to establish a continuous aeration mode. Small bubbles are continuously discharged on the other side of the MBR membrane fiber. The intermittent large bubbles and continuous small bubbles of the multi-union non-blocking staggered gas supply device of the present disclosure generate staggered mixed bubble disturbances on the left and right sides of the MBR membrane fiber to form turbulence, causing the MBR membrane fiber to oscillate irregularly without resonance, reducing the sludge accumulation area of the local non-disturbance zone, thereby peeling off the sludge accumulated on the surface of the MBR membrane fiber during filtration, and also reducing the attachment of suspended sludge to the MBR membrane fiber.

Furthermore, the miniaturized structural integrated membrane bioreactor of the present disclosure having aforementioned the multi-union non-blocking staggered aeration device forms the water production pipeline and aeration pipeline within a metal frame using a gas-liquid co-structure frame, shortening the flow path of the water and gas flow within the frame, and facilitating to dissipate energy losses in the water and gas flow within the pipelines. The gas-liquid co-structure frame eliminates the need for independent plastic piping, reducing the need for additional metal support structures via clamping or other fixing methods. This reduces assembly components and procedures while maintaining structural strength. The reduced size of each module increases the water flow area within the mold tank for brushing, and the design without cover plates helps distribute the water/gas flow field within the mold tank beyond the module itself. This external flow field directly enhances the side brushing of the outer membrane, effectively utilizing the brushing effect of the flow field within the mold tank on the membrane fiber surface. By reducing branch piping and fittings, the fluid resistance around and inside the MBR membrane fibers is reduced, facilitating brushing from the side surfaces of the MBR membrane fibers by a multi-union non-blocking staggered gas supply device. This reduces unnecessary aeration energy waste while still effectively reducing sludge buildup. Therefore, the gas-liquid co-structure frame of the present disclosure features minimal piping, minimal fittings, overall lightweight design, minimal energy consumption, fewer maintenance parts, and maximized service life.

The above description is only an embodiment of the present disclosure and shall not be construed as limiting the scope of the present disclosure. Any simple equivalent changes and modifications made in accordance with the patent application and patent specification of the present disclosure shall still fall within the scope of the patent of the present disclosure.

What is claimed is:

1. A staggered gas supply device, comprising:
at least one gas supply pipe;
a plurality of gas collection chambers arranged along a first direction of the gas supply pipes, the at least one gas supply pipe being in gas communication with the gas collection chambers; and
a plurality of first aeration columns, each comprising: an aeration chamber abutting against a sidewall of the gas collection chambers, wherein the first aeration columns extend beyond the at least one gas supply pipe along a second direction intersecting the at least one gas supply pipe.

2. The staggered gas supply device of claim 1, wherein the aeration chamber comprises a gas baffle and A gas inlet, the gas baffle defines a vortex channel on a sidewall of the gas collection chamber, the gas inlet penetrates the sidewall and is in gas communication with a front end of the vortex channel.

3. The staggered gas supply device of claim 1, further comprising a plurality of second aeration columns abutting against another sidewall of the gas collection chambers, wherein gas outlets of the second aeration columns are larger than or equal to gas outlets of the first aeration column.

4. The staggered gas supply device of claim 1, further comprising an aeration pipe spaced apart from the at least one gas supply pipe, wherein a wall of the aeration pipe comprises a plurality of aeration holes.

5. The staggered gas supply device of claim 4, further comprising a first disturbance mode and a second disturbance mode, wherein the first aeration columns intermittently discharge a plurality of first bubbles in a pulsed manner in the first disturbance mode, and the aeration holes continuously discharge a plurality of second bubbles in the second disturbance mode, the first disturbance mode and the second disturbance mode interact to form turbulence with irregular disturbances.

6. A miniaturized structural integrated membrane bioreactor including the staggered aeration device of claim 1, comprising a gas-liquid co-structured frame, the gas-liquid co-structured frame comprising:
a first hollow frame defining a first perimeter of a first side surface of the gas-liquid co-structured frame, the four sides of the first hollow frame being in liquid communication with each other;
a second hollow frame defining a second perimeter of a second surface side of the gas-liquid co-structured frame, the first side being parallel to the second side, the four sides of the second hollow frame being in liquid communication with each other;
a plurality of water production pipes connected between the first hollow frame and the second hollow frame, the water production pipes being in liquid communication with each other; and
wherein the staggered aeration device is disposed between the first hollow frame and the second hollow frame, at least one aeration pipe of the staggered aeration device is in gas communication with the second hollow frame and is disposed below the water production pipes, and the first aeration columns extending from the staggered aeration device to a side surface of the water production pipes.

7. The miniaturized structural integrated membrane bioreactor of claim 6, wherein the staggered aeration device comprises a plurality of aeration pipes disposed between the first hollow frame and the second hollow frame and between the water production pipes, the aeration pipes are in gas communication with the second hollow frame; and
wherein the staggered aeration device comprises a first disturbance mode and a second disturbance mode, wherein the first aeration columns intermittently discharge a plurality of first bubbles in a pulsed manner in the first disturbance mode, and the aeration holes continuously discharge a plurality of second bubbles in the second disturbance mode, the first disturbance mode and the second disturbance mode interact to form turbulence with irregular disturbances.

8. The miniaturized structural integrated membrane bioreactor of claim 6, wherein the staggered aeration device comprises a plurality of second aeration columns abutting against another sidewall of the gas collection chambers, gas outlets of the second aeration columns are larger than or equal to gas outlets of the first aeration columns,
wherein the staggered aeration device comprises a first disturbance mode and a second disturbance mode, wherein the first aeration columns intermittently discharge a plurality of first bubbles in a pulsed manner in the first disturbance mode, and the aeration holes continuously discharge a plurality of second bubbles in the second disturbance mode, the first disturbance mode and the second disturbance mode interact to form turbulence with irregular disturbances.

9. The miniaturized structural integrated membrane bioreactor of claim 6, further comprising: an I-shaped hanger configured to define a suspension point on a central axis of the miniaturized structural integrated membrane bioreactor.
